(19) United States
(12) Patent Application Publication
(10) Pub. No.: US 2025/0253782 A1
(43) Pub. Date: Aug. 7, 2025

(54) MOTOR DRIVE DEVICE AND MOTOR DRIVE METHOD

(71) Applicant: Nuvoton Technology Corporation Japan, Kyoto (JP)

(72) Inventors: Daisuke FUKUDA, Kyoto (JP); Shinichi KUROSHIMA, Kyoto (JP); Noriaki EMURA, Osaka (JP)

(21) Appl. No.: 19/185,729

(22) Filed: Apr. 22, 2025

Related U.S. Application Data
(63) Continuation of application No. PCT/JP2023/037935, filed on Oct. 19, 2023.

(30) Foreign Application Priority Data
Nov. 1, 2022 (JP) 2022-175741

(51) Int. Cl. H02P 6/17; H02P 6/06; H02P 29/10

(52) U.S. Cl. CPC H02P 6/17; H02P 6/06; H02P 29/10; H02P 2209/13

(57) ABSTRACT

A motor drive device includes: an actual speed signal generator; a target speed signal generator; a speed comparator that compares an actual speed signal and a target speed signal; and a speed command generator that generates a speed command signal according to an output from the speed comparator. The speed command generator includes: a step width generator that generates, according to the output from the speed comparator, a step width signal indicating a step width including a size and a positive or negative sign that correspond to a magnitude of one of the actual speed or the target speed with respect to the other; an update signal generator that generates an update signal; and an accumulation calculator that adds the step width indicated by the step width signal to the speed command signal and outputs a resulting speed command signal, at a timing of the update signal.

### CROSS REFERENCE TO RELATED APPLICATIONS

This is a continuation application of PCT International Patent Application No. PCT/JP2023/037935 filed on Oct. 19, 2023, designating the United States of America, which is based on and claims priority of Japanese Patent Application No. 2022-175741 filed on Nov. 1, 2022. The entire disclosures of the above-identified applications, including the specifications, drawings and claims are incorporated herein by reference in their entirety.

### FIELD

The present disclosure relates to a motor drive device and a motor drive method that rotate a motor at a target speed.

### BACKGROUND

As a technique for rotating a motor at a target speed (hereinafter, also referred to as “speed control”), proportional-integral control (hereinafter, also referred to as “PI control”) has been used for a long time (for example, see Patent Literature (PTL) 1). This technique achieves accurate speed control with a short response time by performing feedback control (proportional control) by feeding back a comparison value of an error between a target speed and an actual speed to a motor speed command, and performing feedback control (integral control) by feeding back an integral value obtained by integrating an error between the target speed and the actual speed.

In the PI control, it is necessary to calculate a proportional value and an integral value of an error between the target speed and the actual speed, and thus the circuit becomes large. In view of this problem, PTL 2 proposes speed control with a simple circuit configuration.

### CITATION LIST

### Patent Literature

PTL 1: Japanese Unexamined Patent Application Publication No. 4-121089
PTL 2: Japanese Unexamined Patent Application Publication No. 6-070594

### SUMMARY

### Technical Problem

However, also in PTL 2, it is necessary to calculate a relational expression between the speed command and the speed for each characteristic of a motor and store a resulting value in memory or the like, and adjustment for each motor is necessary.

The present disclosure aims to provide a motor drive device and a motor drive method that perform speed control with a simple configuration and without requiring adjustment for each motor.

### Solution to Problem

To achieve the above, a motor drive device according to one aspect of the present disclosure includes: an actual speed signal generator that generates an actual speed signal indicating an actual speed of a motor; a target speed signal generator that generates a target speed signal indicating a target speed of the motor; a speed comparator that compares the actual speed indicated by the actual speed signal and the target speed indicated by the target speed signal; a speed command generator that generates a speed command signal according to an output from the speed comparator; and an outputter that generates a drive signal for driving the motor from the speed command signal. The speed command generator includes: a step width generator that generates, according to the output from the speed comparator, a step width signal indicating a step width including a size and a positive or negative sign that correspond to a magnitude of one of the actual speed or the target speed with respect to an other of the actual speed or the target speed; an update signal generator that repeatedly generates an update signal; and an accumulation calculator that adds the step width indicated by the step width signal to the speed command signal and outputs a resulting speed command signal, at a timing of each update signal repeatedly generated.

To achieve the above, a motor drive method according to one aspect of the present disclosure includes: generating an actual speed signal indicating an actual speed of a motor; generating a target speed signal indicating a target speed of the motor; comparing the actual speed indicated by the actual speed signal and the target speed indicated by the target speed signal; generating a speed command signal according to an output from the comparing; and generating a drive signal for driving the motor from the speed command signal. The generating of the speed command signal includes: generating, according to the output from the comparing, a step width signal indicating a step width including a size and a positive or negative sign that correspond to a magnitude of one of the actual speed or the target speed with respect to an other of the actual speed or the target speed; repeatedly generating one or more update signals; and adding the step width indicated by the step width signal to the speed command signal and outputting a resulting speed command signal, at a timing of each update signal repeatedly generated.

### Advantageous Effects

With the present disclosure, the adjustment width of the speed command is reduced as the motor speed approaches the target speed. Therefore, the present disclosure provides a motor drive device and a motor drive method that perform speed control with a simple configuration and without requiring adjustment for each motor.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a configuration of a motor drive device according to an embodiment.

FIG. 2 is a flowchart illustrating an operation example according to Working Example 1 of the motor drive device.

FIG. 3A is a timing diagram illustrating an operation example according to Working Example 1 of the motor drive device.

FIG. 3B is a table illustrating an example of relationships between step width signals (steps 0 to 2) and the amount of change in the speed command signal in FIG. 3A.

FIG. 4 is a flowchart illustrating an operation example according to Working Example 2 of the motor drive device.

FIG. 5A is a timing diagram illustrating an operation example according to Working Example 2 of the motor drive device.

FIG. 5B is a table illustrating an example of relationships between step width signals (steps 0 to 2) and the amount of change in the speed command signal in FIG. 5A.

FIG. 6 is a timing diagram illustrating an operation example according to Working Example 3 of the motor drive device.

FIG. 7 is a timing diagram illustrating a first operation example according to Working Example 4 of the motor drive device.

FIG. 8A is a flowchart illustrating a second operation example according to Working Example 4 of the motor drive device.

FIG. 8B is a flowchart illustrating a third operation example according to Working Example 4 of the motor drive device.

FIG. 8C is a flowchart illustrating a fourth operation example according to Working Example 4 of the motor drive device.

FIG. 9A is a flowchart illustrating a first operation example (initialization of the step width) according to Working Example 5 of the motor drive device.

FIG. 9B is a flowchart illustrating a second operation example (initialization of timing of an update signal) according to Working Example 5 of the motor drive device.

### DESCRIPTION OF EMBODIMENT

The following describes in detail one or more embodiments of the present disclosure with reference to the drawings. Note that each of the one or more embodiments described below is a specific example of the present disclosure. The numerical values, shapes, materials, structural elements, arrangement and connection of the structural elements, steps, order of the steps, etc., described in the following one or more embodiments are given merely by way of illustration and are not intended to limit the present disclosure. Moreover, each figure is not necessarily a precise depiction. In the figures, structural elements that are essentially the same share like reference signs and overlapping description is omitted or simplified. Moreover, expressions such as “A and B are connected” or “A is connected to B” mean that A and B are electrically connected to each other. These mean that not only A and B are directly connected to each other, but also A and B are indirectly connected to each other with another circuit element interposed therebetween.

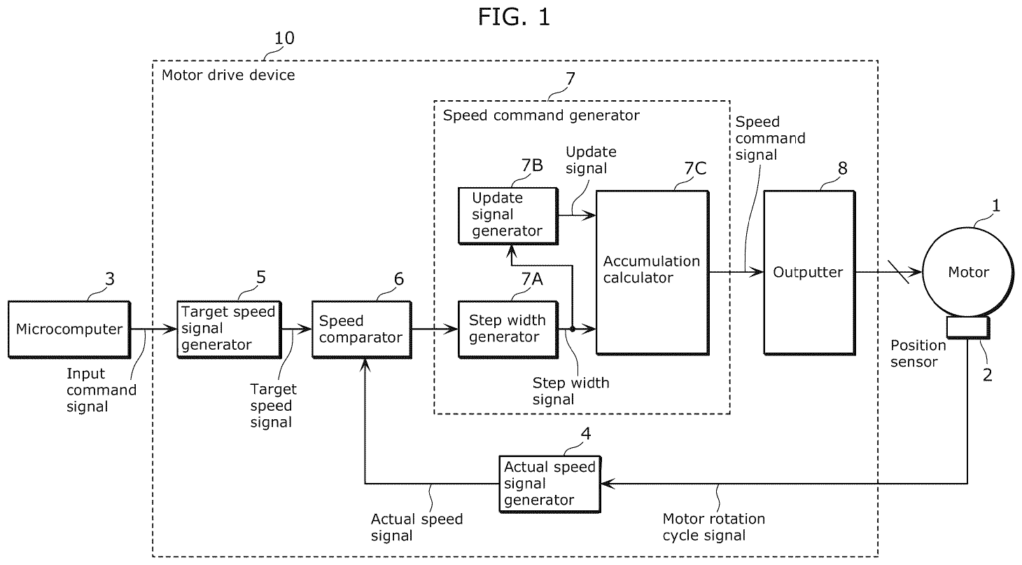

FIG. 1 is a block diagram illustrating a configuration of motor drive device 10 according to an embodiment. Note that, the figure also illustrates microcomputer 3 that gives a command (input command signal) to motor drive device 10; motor 1, which is, for example, a fan motor that is driven by motor drive device 10; and position sensor 2, which is, for example, a Hall sensor that detects a rotor position of motor 1.

Motor drive device 10 is a device that rotates motor 1 at a target speed, and includes actual speed signal generator 4, target speed signal generator 5, speed comparator 6, speed command generator 7, and outputter 8.

Actual speed signal generator 4 generates an actual speed signal that indicates an actual speed, which is a rotational speed of motor 1, based on a signal indicating a position of the rotor of motor 1. The actual speed signal is output by position sensor 2.

Target speed signal generator 5 generates a target speed signal indicating a target speed of motor 1, based on a command (input command signal) given by microcomputer 3.

Speed comparator 6 compares the actual speed indicated by the actual speed signal generated by actual speed signal generator 4 and the target speed indicated by the target speed signal generated by target speed signal generator 5. For example, speed comparator 6 outputs a speed error, which is a difference between the actual speed indicated by the actual speed signal and the target speed indicated by the target speed signal (for example, a difference with a polarity (sign) obtained by subtracting the target speed from the actual speed).

Speed command generator 7 is a processing unit that generates a speed command signal according to an output from speed comparator 6, and includes step width generator 7A, update signal generator 7B, and accumulation calculator 7C. Step width generator 7A generates, according to the output from speed comparator 6, a step width signal indicating a step width including a size and a positive or negative sign that correspond to a magnitude of one of the actual speed indicated by the actual speed signal or the target speed indicated by the target speed signal with respect to the other of the actual speed indicated by the actual speed signal or the target speed indicated by the target speed signal. Update signal generator 7B repeatedly generates an update signal. Accumulation calculator 7C adds the step width indicated by the step width signal generated by step width generator 7A to an immediately preceding speed command signal and outputs a resulting speed command signal to outputter 8, at a timing of each update signal repeatedly generated by update signal generator 7B.

Outputter 8 generates a drive signal, such as a pulse width modulation signal for driving motor 1, from the speed command signal output from speed command generator 7, and outputs the drive signal to motor 1.

Note that, each structural element included in motor drive device 10 may be implemented as hardware, using a dedicated electronic circuit, and, alternatively, may be implemented as software, using, for example, a microcomputer including memory for storing a program, etc.; a processor that executes the program; and an input/output circuit (including an A/D converter, a D/A converter, and a digital input/output circuit, for example). Moreover, various signals generated by motor drive device 10 may each be an analog signal indicating content of information by the magnitude of a voltage, or a digital signal indicating content of information by a value of a binary number or a duty ratio.

Next, Working Examples 1 to 5 will be described as specific operation examples (motor drive method) of motor drive device 10 according to the present embodiment that is configured as described above.

### Working Example 1

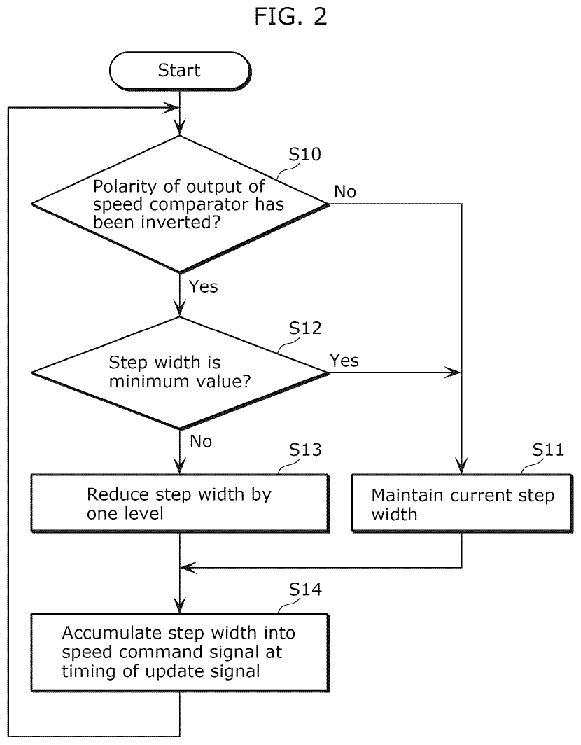

FIG. 2 is a flowchart illustrating an operation example according to Working Example 1 of motor drive device 10.

First, step width generator 7A determines whether the polarity of the output from speed comparator 6 has been inverted (S10). When step width generator 7A determines that the polarity has not been inverted (No in S10), step width generator 7A maintains a current value as the step width (S11). On the other hand, when step width generator 7A determines that the polarity has been inverted (Yes in S10), step width generator 7A subsequently determines whether the current step width is a predetermined minimum value (S12).

As a result, when step width generator 7A determines that the current step width is the predetermined minimum value (Yes in S12), step width generator 7A maintains the current value as the step width (S11). On the other hand, when step width generator 7A determines that the current step width is not the predetermined minimum value (No in S12), step width generator 7A reduces the step width by one level (S13).

Next, accumulation calculator 7C, which has received the step width signal indicating the step width maintained (S11) or updated (S13) by step width generator 7A, accumulates, at a timing of the update signal received from update signal generator 7B, the step width indicated by the step width signal received from step width generator 7A to an immediately preceding speed command signal, and outputs a speed command signal resulting from accumulation to outputter 8 (S14).

Motor drive device 10 repeats the above processes (S10 to S14) at a rate faster than the timing of the update signal.

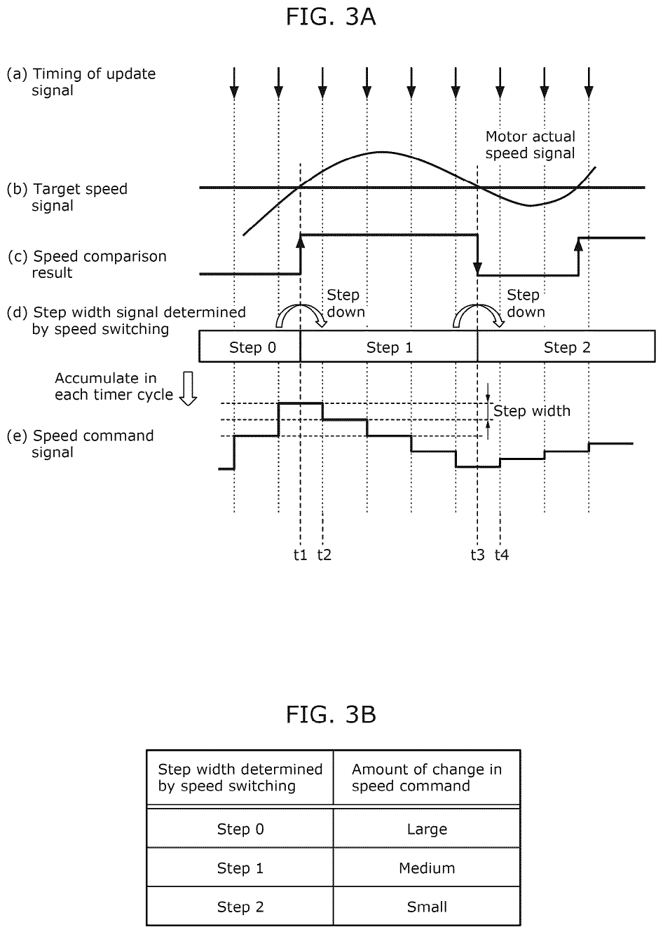

FIG. 3A is a timing diagram illustrating an operation example according to Working Example 1 of motor drive device 10. In FIG. 3A, (a) illustrates a timing of the update signal, (b) illustrates a target speed signal and an actual speed signal, (c) illustrates a speed comparison result by speed comparator 6, (d) illustrates a step width signal determined by speed switching (i.e., step width signal generated by step width generator 7A), and (e) illustrates a speed command signal. FIG. 3B is a table illustrating an example of relationships between step width signals (steps 0 to 2) and the amount of change in the speed command signal in FIG. 3A.

In FIG. 3A, for example, at time t1, the actual speed exceeds the target speed ((b) in FIG. 3A) and thus the polarity of the speed comparison result is inverted ((c) in FIG. 3A). With this, the step width is updated by step width generator 7A from the previous “step 0” to “step 1”, which is a smaller step and includes an inverse polarity (here, a negative sign) ((d) in FIG. 3A). As a result, at time t2, which is the timing of the next update signal, accumulation calculator 7C outputs a speed command signal obtained by accumulating step 1 into an immediately preceding speed command signal. With this process, the speed indicated by the speed command signal is reduced by a width that is one level smaller ((e) in FIG. 3A).

Moreover, at time t3, the actual speed has decreased from the target speed ((b) in FIG. 3A), and thus the polarity of the speed comparison result is inverted ((c) in FIG. 3A). With this, the step width is updated by step width generator 7A from the previous “step 1” to “step 2” including an even smaller step and an inverse polarity (here, a positive sign) ((d) in FIG. 3A). As a result, at time t4, which is a timing of the next update signal, accumulation calculator 7C outputs a speed command signal obtained by accumulating step 2 into an immediately preceding speed command signal. With this process, the speed indicated by the speed command signal is increased by a width that is yet another level smaller ((e) in FIG. 3A).

As described above, motor drive device 10 according to the present embodiment includes: actual speed signal generator 4 that generates an actual speed signal indicating an actual speed of motor 1; target speed signal generator 5 that generates a target speed signal indicating a target speed of motor 1; speed comparator 6 that compares the actual speed indicated by the actual speed signal and the target speed indicated by the target speed signal; speed command generator 7 that generates a speed command signal according to an output from speed comparator 6; and outputter 8 that generates a drive signal for driving motor 1 from the speed command signal. Speed command generator 7 includes: step width generator 7A that generates, according to the output from speed comparator 6, a step width signal indicating a step width including a size and a positive or negative sign that correspond to a magnitude of one of the actual speed or the target speed with respect to an other of the actual speed or the target speed; update signal generator 7B that repeatedly generates an update signal; and accumulation calculator 7C that adds the step width indicated by the step width signal to the speed command signal and outputs a resulting speed command signal, at a timing of each update signal repeatedly generated.

Moreover, a motor drive method according to the present embodiment is a method of driving motor 1 by motor drive device 10, and includes: generating an actual speed signal indicating an actual speed of a motor (processing by actual speed signal generator 4); generating a target speed signal indicating a target speed of the motor (processing by target speed signal generator 5); comparing the actual speed indicated by the actual speed signal and the target speed indicated by the target speed signal (processing by speed comparator 6); generating a speed command signal according to an output from the comparing (processing by speed command generator 7); and generating a drive signal for driving the motor from the speed command signal (processing by outputter 8). The generating of the speed command signal includes: generating, according to the output from the comparing, a step width signal indicating a step width including a size and a positive or negative sign that correspond to a magnitude of one of the actual speed or the target speed with respect to an other of the actual speed or the target speed (processing by step width generator 7A); repeatedly generating one or more update signals (processing by update signal generator 7B); and adding the step width indicated by the step width signal to the speed command signal and outputting a resulting speed command signal, at a timing of each update signal repeatedly generated (processing by accumulation calculator 7C).

With this, a new speed command signal is calculated by accumulating a step width including a sign according to the comparison result between the actual speed and the target speed into the speed command signal. Therefore, the speed control can be performed by easy processes, which are comparison and accumulation. In other words, motor drive device 10 according to the present embodiment does not require complicated PI control as in PTL 1, or calculating a relational expression between the speed command and the speed for each characteristic of the motor and storing the calculated relational expressions in memory or the like, as in PTL 2. Motor drive device 10 according to the present embodiment implements speed control with a simple configuration and without requiring adjustment for each motor.

Moreover, in Working Example 1, when a magnitude relationship between the actual speed and the target speed is inverted, step width generator 7A reduces the size of the step width, the magnitude relationship being indicated by the output of speed comparator 6. With this, the adjustment amount for the speed command signal is gradually reduced, and thus the actual speed reliably converges to the target speed.

Note that in the present working example, as illustrated in FIG. 3B, although three levels of steps 0 to 2 are set for the step width determined by speed switching, the levels of the step width should not be construed to be limited to this number. The step width may be set to two levels or four or more levels.

### Working Example 2

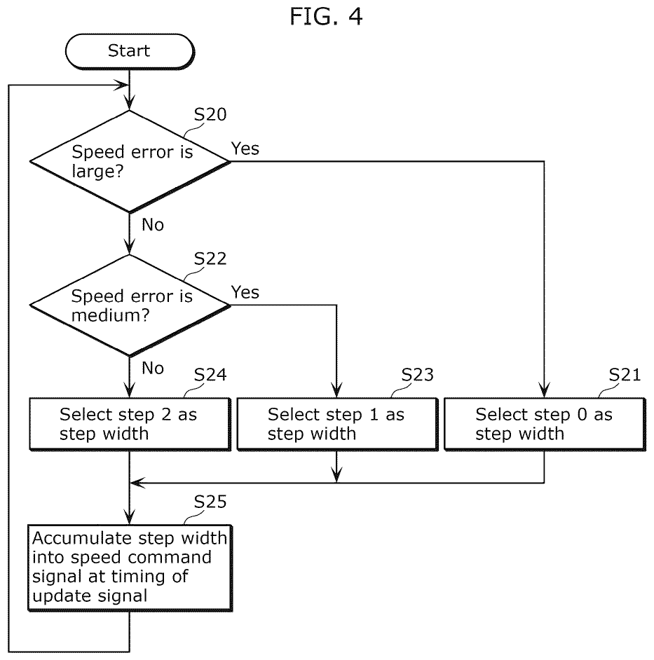

FIG. 4 is a flowchart illustrating an operation example according to Working Example 2 of motor drive device 10.

First, step width generator 7A determines whether a speed error output from speed comparator 6 belongs to “large”, which is a predetermined range (S20). When step width generator 7A determines that the speed error belongs to “large” (Yes in S20), step width generator 7A selects “step 0” which indicates a largest step width among the predetermined three types of step widths (S21). On the other hand, when step width generator 7A determines that the speed error does not belong to “large” (No in S20), step width generator 7A subsequently determines whether the speed error output from speed comparator 6 belongs to “medium”, which is a predetermined range of values that is one level smaller than “large” (S22). Note that the speed error indicates a difference with a sign obtained by subtracting a target speed from an actual speed, and the step width is set to a value with a sign opposite to the sign of the speed error. Moreover, “large” and “small” each indicate a comparison result using absolute values.

As a result, when step width generator 7A determines that the speed error belongs to “medium” (Yes in S22), step width generator 7A selects, as the step width, “step 1” indicating the second largest step width among the predetermined three types of step widths (S23). On the other hand, when step width generator 7A determines that the speed error does not belong to “medium” (No in S22), step width generator 7A selects, as the step width, “step 2” indicating the smallest step width among the predetermined three types of step widths (S24).

Next, accumulation calculator 7C, which has received the step width signal indicating the step width selected by step width generator 7A (S21, S23, and S24), accumulates the step width indicated by the step width signal received from step width generator 7A into an immediately preceding speed command signal and outputs a speed command signal resulting from accumulation to outputter 8, at the timing of the update signal received from update signal generator 7B (S25).

Motor drive device 10 repeats the above processes (S20 to S25) at a rate faster than the timing of the update signal.

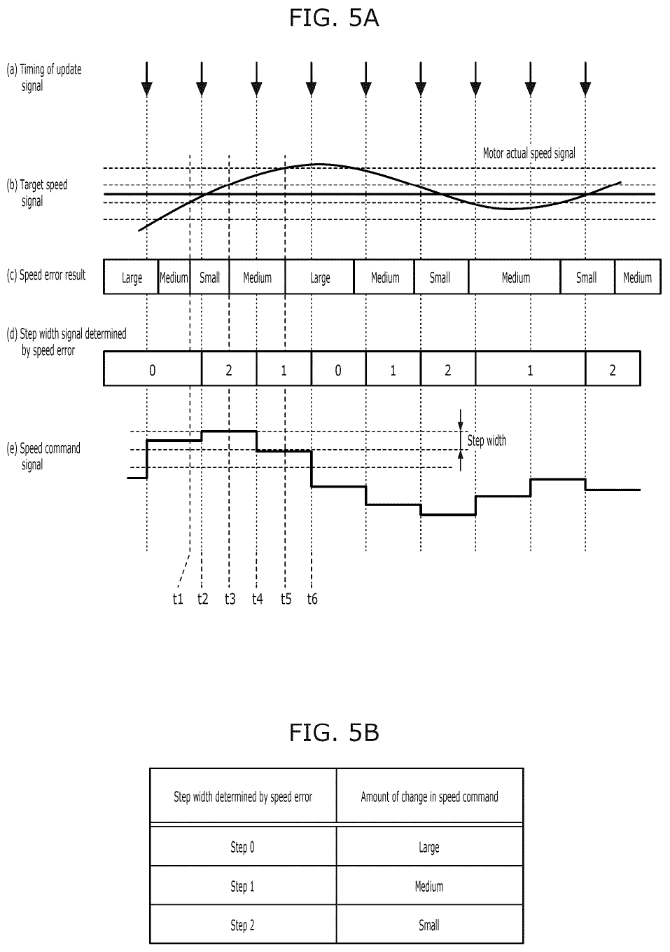

FIG. 5A is a timing diagram illustrating an operation example according to Working Example 2 of motor drive device 10. In FIG. 5A, (a) illustrates a timing of the update signal, (b) illustrates a target speed signal and an actual speed signal, (c) illustrates a speed error signal output from speed comparator 6, (d) illustrates a step width signal determined by the speed error (i.e., step width signal generated by step width generator 7A), and (e) illustrates a speed command signal. FIG. 5B is a table illustrating an example of relationships between step width signals (steps 0 to 2) and the amount of change in the speed command signal in FIG. 5A.

In FIG. 5A, for example, at time t1, although the actual speed is lower than the target speed, the difference between the actual speed and the target speed is small ((b) in FIG. 5A), and thus the speed error output from the speed comparator indicates “small” ((c) in FIG. 5A). With this, at time t2, which is the timing of the next update signal, step width generator 7A selects, as the step width, “step 2” including a positive sign and indicating the smallest step width ((d) in FIG. 5A), and accumulation calculator 7C outputs a speed command signal obtained by accumulating “step 2” into an immediately preceding speed command signal. With this process, the speed indicated by the speed command signal is increased by the smallest width ((e) in FIG. 5A).

Moreover, at time t3, although the actual speed is higher than the target speed, the difference between the actual speed and the target speed is approximately medium ((b) in FIG. 5A), and thus the speed error output from the speed comparison result indicates “medium” ((c) in FIG. 5A). With this, at time t4, which is the timing of the next update signal, step width generator 7A selects “step 1” including a negative sign and indicating an approximately medium step width, as the step width ((d) in FIG. 5A), and accumulation calculator 7C outputs the speed command signal obtained by accumulating “step 1” into an immediately preceding speed command signal. With this process, the speed indicated by the speed command signal is reduced by an approximately medium width ((e) in FIG. 5A).

Moreover, at time t5, the actual speed is even higher than the target speed and the difference between the actual speed and the target speed becomes larger ((b) in FIG. 5A), and thus the speed error output from the speed comparison result indicates “large” ((c) in FIG. 5A). With this, at time t6, which is the timing of the next update signal, step width generator 7A selects, as the step width, “step 0” including a negative sign and indicating the largest step width ((d) in FIG. 5A), and accumulation calculator 7C outputs the speed command signal obtained by accumulating “step 0” into an immediately preceding speed command signal. With this process, the speed indicated by the speed command signal is reduced by the maximum width ((e) in FIG. 5A).

As described above, in the operation example of Working Example 2, speed comparator 6 outputs a speed error that is a difference between the actual speed indicated by the actual speed signal and the target speed indicated by the target speed signal, and when the speed error becomes less than or equal to a predetermined value, step width generator 7A reduces the size of the step width. With this, when the speed error is less than or equal to the predetermined value, the adjustment width of the speed command signal becomes small, and thus the actual speed reliably converges to the target speed.

Note that in the present working example, as illustrated in FIG. 5B, although three levels of steps 0 to 2 are set for the step width determined by the speed error, the levels of the step width should not be construed to be limited to this number. The step width may be set to two levels or four or more levels.

### Working Example 3

Working Example 3 is an operation example of motor drive device 10 that has adopted both controls in Working Examples 1 and 2, and has a feature that a smaller step width is used between a step width selected by control in Working Example 1 and a step width selected by control in Working Example 2 to update the speed command signal. In other words, when (i) a magnitude relationship between the actual speed and the target speed is inverted, step width generator 7A reduces the size of the step width, and when (ii) the speed error becomes less than or equal to the predetermined value concurrently with (i), step width generator 7A selects a smaller step width between a step width resulting from (i) and a step width resulting from (ii), the magnitude relationship being indicated by the output of speed comparator 6, the speed error being output by speed comparator 6.

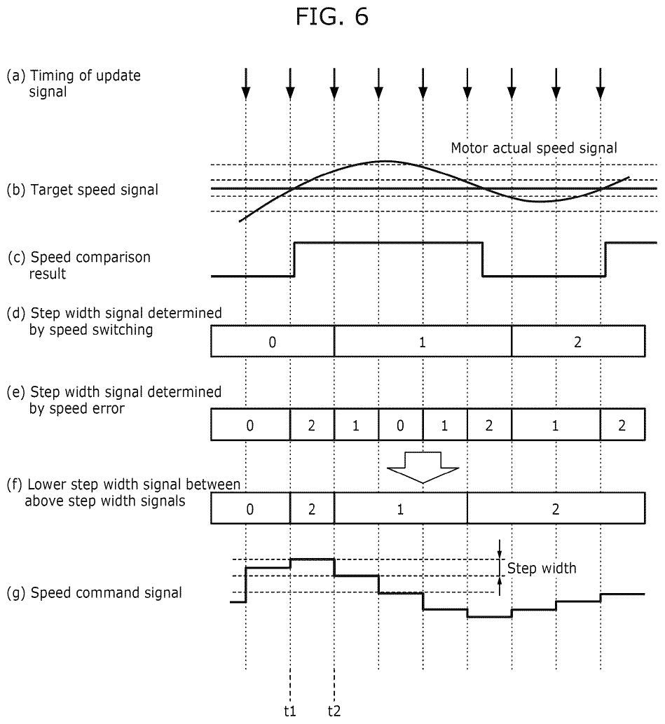

FIG. 6 is a timing diagram illustrating an operation example according to Working Example 3 of motor drive device 10. In FIG. 6, (a) illustrates a timing of the update signal, (b) illustrates a target speed signal and an actual speed signal, (c) illustrates a speed comparison result by speed comparator 6, (d) illustrates a step width signal determined by speed switching, (e) illustrates a step width signal determined by a speed error, (f) illustrates a step width signal indicating a smaller step width between the above two step width signals, and (g) illustrates a speed command signal.

In FIG. 6, for example, at time t1, since the actual speed continues to be lower than the target speed until then ((b) in FIG. 6), “step 0” including a positive sign is selected ((d) in FIG. 6) as a step width signal determined by speed switching according to the control in Working Example 1.

Moreover, at time t1, although the actual speed is lower than the target speed, the difference between the actual speed and the target speed is small ((b) in FIG. 6), and thus “step 2” including a positive sign is selected as a step width signal determined by the speed error according control of Working Example 2 ((e) in FIG. 6).

As a result, in the present working example, at time t1, step width generator 7A selects and outputs, as the step width signal, “step 2” including a positive sign and a smaller step width ((f) in FIG. 6) between “step 0” including a positive sign, which is selected as a step width signal determined by speed switching ((d) in FIG. 6), and “step 2” including a positive sign, which is selected as a step width signal determined by the speed error ((e) in FIG. 6). Therefore, accumulation calculator 7C outputs a speed command signal obtained by accumulating “step 2” including a positive sign to an immediately preceding speed command signal. With this process, the speed indicated by the speed command signal is increased by the minimum width ((g) in FIG. 6).

Note that, at time t1, since the actual speed exceeds the target speed ((b) in FIG. 6), the polarity of the speed comparison result is inverted ((c) in FIG. 6) according to the control in Working Example 1. With this, at time t2, which is the timing of the next update signal, “step 1” including an inverse polarity (here, a negative sign) and a width that is one level smaller than the width of the previous “step 0” is determined as the step width signal determined by speed switching ((d) in FIG. 6).

Moreover, at time t2, although the actual speed is higher than the target speed, the difference between the actual speed and the target speed is approximately medium ((b) in FIG. 6), and thus “step 1” including a negative sign is selected as a step width signal determined by the speed error according to control of Working Example 2 ((e) in FIG. 6) described above.

As a result, in the present working example, at time t2, step width generator 7A selects and outputs, as the step width signal, “step 1” (because, here, the same step width) including a negative sign and a smaller step width ((f) in FIG. 6) between “step 1” including a negative sign, which is selected as a step width signal determined by speed switching ((d) in FIG. 6), and “step 1” including a negative sign, which is selected as a step width signal determined by the speed error ((e) in FIG. 6). Therefore, accumulation calculator 7C outputs a speed command signal obtained by accumulating “step 1” including a positive sign into an immediately preceding speed command signal. With this process, the speed indicated by the speed command signal is reduced by an approximately minimum width ((g) in FIG. 6).

As described above, in the operation example of Working Example 3, when (i) a magnitude relationship between the actual speed and the target speed, step width generator 7A reduces the size of the step width, and when (ii) the speed error becomes less than or equal to a predetermined value concurrently with (i), step width generator 7A selects a smaller step width between a step width resulting from (i) and a step width resulting from (ii), the magnitude relationship being indicated by output of speed comparator 6. With this, the control for gradually reducing the adjustment amount for the speed command signal and the control for reducing the adjustment width of the speed command signal when the speed error is less than or equal to the predetermined value are performed concurrently. Consequently, the actual speed can converge to the target speed more reliably.

### Working Example 4

Working Example 4 has a feature that a predetermined minimum value is set for the step width, and when the step width continues to be the predetermined minimum value, update signal generator 7B extends the timing of the update signal.

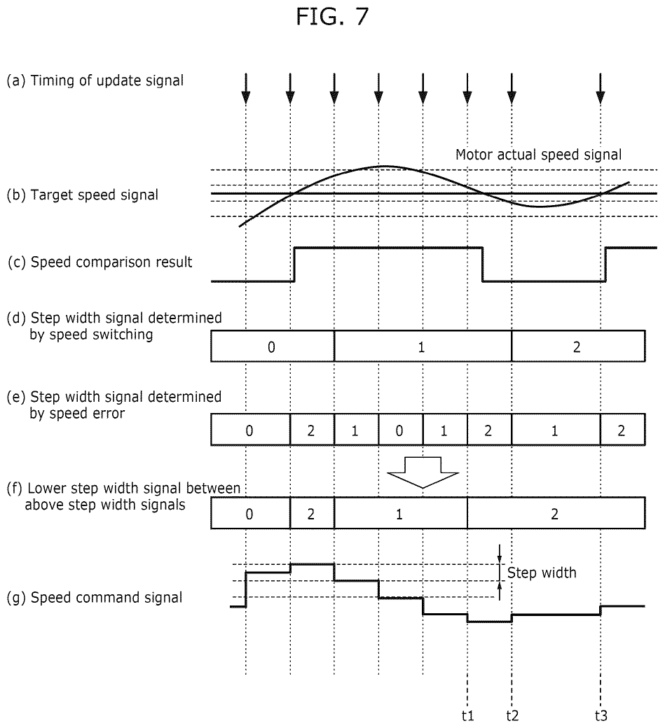

The control in this Working Example 4 can be used in combination with any of the controls in the above-described Working Examples 1 to 3. Therefore, the operation example when the control in Working Example 4 is incorporated into the control in Working Example 3 will be described with reference to the timing diagram in FIG. 7 as a first operation example according to Working Example 4.

FIG. 7 is a timing diagram illustrating a first operation example according to Working Example 4 of motor drive device 10. In FIG. 7, (a) illustrates a timing of the update signal, (b) illustrates a target speed signal and an actual speed signal, (c) illustrates a speed comparison result by speed comparator 6, (d) illustrates a step width signal determined by speed switching, (e) illustrates a step width signal determined by a speed error, (f) illustrates a step width signal indicating a smaller step width between the above two step width signals, and (g) illustrates a speed command signal.

Here, the same operation as Working Example 3 illustrated in FIG. 6 is performed until time t2.

However, in the present working example, at time t1, “step 2” including a negative sign and a smaller step width is selected between “step 1” including a negative sign, which is selected as a step width signal determined by speed switching ((d) in FIG. 7), and “step 2” including a negative sign, which is selected as a step width signal determined by the speed error ((e) in FIG. 7), and is output by step width generator 7A as the step width signal ((f) in FIG. 6). At subsequent time t2, “step 2” including a positive sign and a smaller step width is selected between “step 2” including a positive sign, which is selected as a step width signal determined by speed switching ((d) in FIG. 7), and “step 1” including a positive sign, which is selected as a step width signal determined by the speed error ((e) in FIG. 7), and is output by step width generator 7A as the step width signal ((f) in FIG. 6).

In other words, at time t1 and time t2, the step width continues to be the minimum value (i.e., “step 2”). Therefore, update signal generator 7B detects at time t2 that the step width signal indicating the minimum step width is continuously output from step width generator 7A, and extends the timing (time t3) of the next update signal ((a) in FIG. 7).

Specifically, when update signal generator 7B detects that the step width signal has been output continuously, update signal generator 7B changes the cycle of output of the update signal, for example, to two times the basic cycle thereafter. Therefore, at the next time point after time t2, an update signal is output at time t3 at which two times the previous cycle has elapsed, and at time t3, a speed command signal obtained by accumulating “step 2” including a positive sign into an immediately preceding speed command signal is output from accumulation calculator 7C, and the speed indicated by the speed command signal increases by an approximately medium width ((g) in FIG. 7). Note that, when a similar event is detected again, the cycle of output of the update signal is changed from two times to three times the previous basic cycle.

As described above, in the first operation example of Working Example 4, a predetermined minimum value is set for the step width, and when the step width continues to be the predetermined minimum value, update signal generator 7B extends the timing of the update signal. With this, when the step width continues to be the minimum value, the frequency of adjustment for the speed command signal is reduced, and thus the actual speed can converge to the target speed more reliably.

Note that, in the first operation example of Working Example 4, the extension of the timing of output of the update signal has been extended in the order of the basic cycle, two times the basic cycle, three times the basic cycle, and so on, but the present disclosure should not be construed to be limited to such extension patterns. For example, the timing may be extended in the order of the basic cycle, three times the cycle, six times the cycle, and so on.

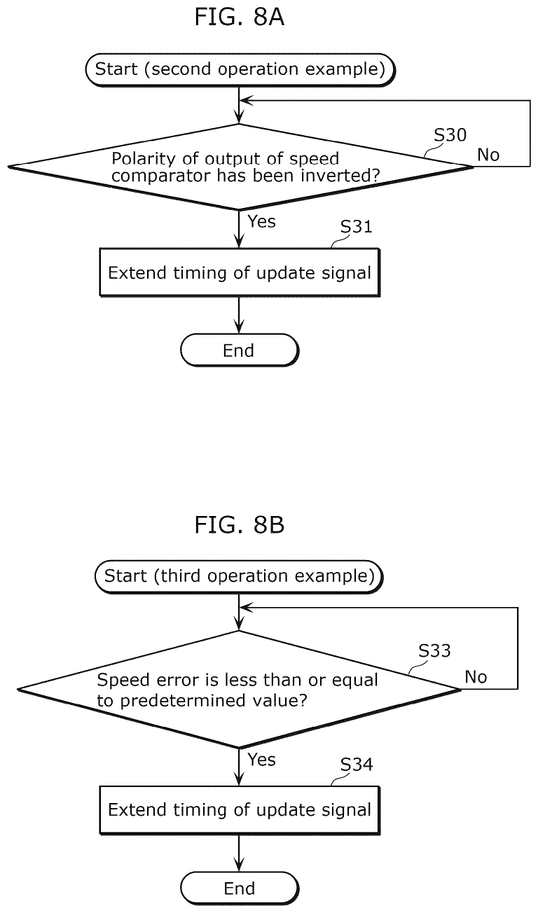

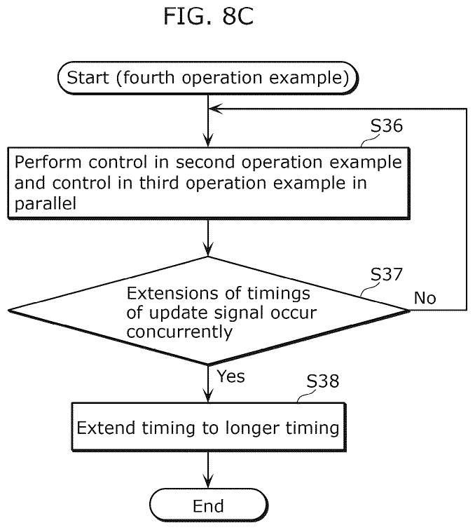

In addition, the control of extending the timing of the update signal is not limited to the cases where the step width continues to be the minimum value as in the first operation example above, but can also be applied to the case in other conditions. The other application examples will be described below as second to fourth operation examples according to Working Example 4 with reference to FIGS. 8A to 8C.

FIG. 8A is a flowchart illustrating a second operation example according to Working Example 4 of motor drive device 10.

Update signal generator 7B monitors whether the magnitude relationship between the actual speed and the target speed, which is indicated by the output of speed comparator 6, has been inverted (S30). When update signal generator 7B determines that the magnitude relationship between the actual speed and the target speed is inverted (Yes in S30), update signal generator 7B extends the timing of the update signal (S31). Specifically, when update signal generator 7B detects that the magnitude relationship has been inverted, update signal generator 7B changes the cycle of output of the update signal, for example, to two times the basic cycle thereafter. Note that, when update signal generator 7B determines that the magnitude relationship between the actual speed and the target speed has not been inverted (No in S30), update signal generator 7B repeats the determination (S30) without performing processing related to the extension of the timing of the update signal.

As described above, in the second operation example of Working Example 4, when a magnitude relationship between the actual speed and the target speed is inverted, update signal generator 7B extends the timing of the update signal, the magnitude relationship being indicated by the output of speed comparator 6. With this, when the magnitude relationship between the actual speed and the target speed is inverted, the frequency of adjustment for the speed command signal is reduced, and the actual speed reliably converges to the target speed.

FIG. 8B is a flowchart illustrating a third operation example according to Working Example 4 of motor drive device 10.

Update signal generator 7B monitors whether the speed error output by speed comparator 6 is less than or equal to a predetermined value (S33). When update signal generator 7B determines that the speed error is less than or equal to the predetermined value (Yes in S33), update signal generator 7B extends the timing of the update signal (S34). Specifically, when update signal generator 7B detects that the speed error output by speed comparator 6 belongs to “small” which is predetermined, update signal generator 7B changes the cycle of outputting the update signal, for example, to two times the basic cycle thereafter. Note that, when update signal generator 7B determines that the speed error is not less than or equal to the predetermined value (No in S33), update signal generator 7B repeats the determination (S33) without performing processing related to the extension of the timing of the update signal.

As described above, in the third operation example of Working Example 4, speed comparator 6 outputs a speed error that is a difference between the actual speed indicated by the actual speed signal and the target speed indicated by the target speed signal, and when the speed error becomes less than or equal to a predetermined value, update signal generator 7B extends the timing of the update signal. With this, when the speed error becomes less than or equal to the predetermined value, the frequency of adjustment for the speed command signal is reduced, and the actual speed reliably converges to the target speed.

FIG. 8C is a flowchart illustrating a fourth operation example according to Working Example 4 of motor drive device 10.

Update signal generator 7B performs the control in the second operation example illustrated in FIG. 8A and the control in the third operation example illustrated in FIG. 8B in parallel (S36).

At this time, update signal generator 7B determines whether (i) the extension of timing of the update signal due to the control of the second operation example is to occur concurrently with (ii) the extension of the timing of the update signal due to the control of the third operation example (S37). When update signal generator 7B determines that the extensions of timings of the update signal occur concurrently (Yes in S37), update signal generator 7B extends the timing of the update signal to a longer timing (when the timings are the same, the timing is extended to the same timing) (S38) between a timing resulting from (i) and a timing resulting from (ii).

Specifically, when the extension of the timing of the update signal is to change to two times the basic cycle by the control in the second operation example (i.e., due to inversion of the polarity of the output by speed comparator 6) and the extension of the timing is to change to three times the basic cycle by the control in the third operation example (i.e., due to the speed error becoming less than or equal to the predetermined value), update signal generator 7B changes the timing to three times the basic cycle, which is a longer cycle.

Note that, when the extension of the timing of the update signal by the control in the second operation example will not occur concurrently with the extension of the timing of the update signal by the control in the third operation example (No in S37), update signal generator 7B repeats the processes of step S36 and S37 without performing the processing related to extension of the timing of the update signal.

As described above, in the fourth operation example of Working Example 4, when (i) a magnitude relationship between the actual speed and the target speed is inverted, update signal generator 7B extends the timing of the update signal, and when (ii) the speed error becomes less than or equal to a predetermined value concurrently with (i), update signal generator 7B selects a longer timing of the update signal between a timing of the update signal resulting from (i) and a timing of the update signal resulting from (ii), the magnitude relationship being indicated by the output of speed comparator 6. With this, when two types of timings of the update signal occur concurrently due to two types of events, a longer one of the timings is selected. Therefore, the frequency of adjustment for the speed command signal is reduced, and the actual speed reliably converges to the target speed.

### Working Example 5

Working Example 5 relates to initialization control for the step width and the timing of the update signal.

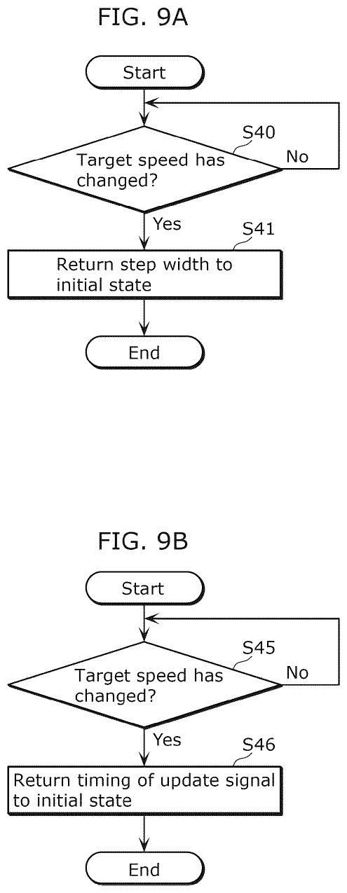

FIG. 9A is a flowchart illustrating a first operation example (initialization of the step width) according to Working Example 5 of motor drive device 10.

Step width generator 7A monitors an input command signal input to target speed signal generator 5 and determines whether the target speed indicated by the input command signal has changed (S40). When step width generator 7A determines that the target speed has changed (Yes in S40), the size of the step width is returned to the initial state (S41). Specifically, when step width generator 7A determines that the target speed has changed, step width generator 7A outputs a step width signal indicating “step 0” at the timing of the next update signal. Note that, when step width generator 7A determines that the target speed has not changed (No in S40), step width generator 7A repeats the determination (S40) without performing the processing related to the initialization of the step width.

As described above, in the first operation example in Working Example 5, when a value of the target speed signal has changed, step width generator 7A returns the size of the step width to an initial state. With this, when the target speed has changed, adjustment for the speed command signal is started again using a new step width that has been initialized for a new target speed, and the actual speed reliably converges to the new target speed.

Note that, the control according to the first operation example of Working Example 5 can be used in combination with any of the controls in the above-described Working Examples 1 to 4.

FIG. 9B is a flowchart illustrating a second operation example (initialization of timing of the update signal) according to Working Example 5 of motor drive device 10.

Update signal generator 7B monitors an input command signal input to target speed signal generator 5 and determines whether the target speed indicated by the input command signal has changed (S45). When update signal generator 7B determines that the target speed has changed (Yes in S45), the timing of the update signal is returned to the initial state (S46). Specifically, when update signal generator 7B determines that the target speed has changed, the update signal is output in a basic cycle predetermined as an initial value, starting from the update signal to be output next. Note that, when update signal generator 7B determines that the target speed has not changed (No in S45), update signal generator 7B repeats the determination (S45) without performing the processing related to the initialization of the timing of the update signal.

As described above, in the second operation example of Working Example 5, when a value of the target speed signal has changed, update signal generator 7B returns the timing of the update signal to an initial state. With this, when the target speed has changed, adjustment for the speed command signal is started again using a new timing that has been initialized for a new target speed, and the actual speed reliably converges to the new target speed.

Note that, the control according to the second operation example of Working Example 5 can be used in combination with the control of extending the timing of the update signal in the above-described Working Example 4.

Hereinbefore, the motor drive device and the motor drive method according to the present disclosure have been described based on the embodiment and Working Examples 1 to 5, but the present disclosure should not be construed to be limited to the embodiment and working examples. The scope of the present disclosure may encompass embodiments as a result of making, to the embodiment, various modifications that may be conceived by those skilled in the art, and different embodiments achieved by combining one or more structural elements in the embodiment and working examples, as long as the resultant embodiments do not depart from the spirit of the present disclosure.

For example, control may be performed in combination of working examples and operation examples selected as follows: one of Working Examples 1 to 3 for the step width selection, one of the first to fourth operation examples of Working Example 4 for the timing of the update signal, the first operation example of Working Example 5 for the step width initialization, and the second operation example of Working Example 5 for the initialization of the timing of the update signal.

In addition, update signal generator 7B may generate an update signal based on the actual speed signal generated by actual speed signal generator 4. In more detail, update signal generator 7B may generate an update signal based on a rotor position signal (i.e., a signal indicating the rotor position of motor 1 that is output by position sensor 2) used for generation of the actual speed signal. For example, in Working Example 4, update signal generator 7B may extend the timing of the update signal depending on the actual speed signal. In Working Example 5, when not only the value of the target speed signal but also the value of actual speed signal has changed, update signal generator 7B may return the timing of the update signal to the initial state.

In addition, the motor drive device according to the present disclosure may be implemented as a program including each of the steps of the motor drive method according to the present disclosure and as a computer readable recording medium such as a digital versatile disc (DVD) in which such a program is stored.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be used as a motor drive device that rotates a motor at a target speed, and in particular, as a motor drive device that performs speed control with a simple configuration and without requiring adjustment for each motor, for example, as a drive device for a fan motor.

1. A motor drive device comprising:
an actual speed signal generator that generates an actual speed signal indicating an actual speed of a motor;
a target speed signal generator that generates a target speed signal indicating a target speed of the motor;
a speed comparator that compares the actual speed indicated by the actual speed signal and the target speed indicated by the target speed signal;
a speed command generator that generates a speed command signal according to an output from the speed comparator; and
an outputter that generates a drive signal for driving the motor from the speed command signal, wherein
the speed command generator includes:
a step width generator that generates, according to the output from the speed comparator, a step width signal indicating a step width including a size and a positive or negative sign that correspond to a magnitude of one of the actual speed or the target speed with respect to an other of the actual speed or the target speed;
an update signal generator that repeatedly generates an update signal; and
an accumulation calculator that adds the step width indicated by the step width signal to the speed command signal and outputs a resulting speed command signal, at a timing of each update signal repeatedly generated.

2. The motor drive device according to claim 1, wherein
when a magnitude relationship between the actual speed and the target speed is inverted, the step width generator reduces the size of the step width, the magnitude relationship being indicated by the output of speed comparator.

3. The motor drive device according to claim 1, wherein
the speed comparator outputs a speed error that is a difference between the actual speed and the target speed, and
when the speed error becomes less than or equal to a predetermined value, the step width generator reduces the size of the step width.

4. The motor drive device according to claim 3, wherein
when (i) a magnitude relationship between the actual speed and the target speed is inverted, the step width generator reduces the size of the step width, and when (ii) the speed error becomes less than or equal to the predetermined value concurrently with (i), the step width generator selects a smaller step width between a step width resulting from (i) and a step width resulting from (ii), the magnitude relationship being indicated by output of the speed comparator.

5. The motor drive device according to claim 2, wherein
a predetermined minimum value is set for the step width, and when the step width continues to be the predetermined minimum value, the update signal generator extends the timing of the update signal.

6. The motor drive device according to claim 2, wherein
when a value of the target speed signal has changed, the step width generator returns the size of the step width to an initial state.

7. The motor drive device according to claim 5, wherein
when a value of the target speed signal has changed, the update signal generator returns the timing of the update signal to an initial state.

8. The motor drive device according to claim 1, wherein
when a magnitude relationship between the actual speed and the target speed is inverted, the update signal generator extends the timing of the update signal, the magnitude relationship being indicated by the output of the speed comparator.

9. The motor drive device according to claim 1, wherein
the speed comparator outputs a speed error that is a difference between the actual speed and the target speed, and
when the speed error becomes less than or equal to a predetermined value, the update signal generator extends the timing of the update signal.

10. The motor drive device according to claim 9, wherein
when (i) a magnitude relationship between the actual speed and the target speed is inverted, the update signal generator extends the timing of the update signal, and when (ii) the speed error becomes less than or equal to a predetermined value concurrently with (i), the update signal generator selects a longer timing of the update signal between a timing of the update signal resulting from (i) and a timing of the update signal resulting from (ii), the magnitude relationship being indicated by the output of the speed comparator.

11. The motor drive device according to claim 1, wherein
the update signal generator generates the update signal based on the actual speed indicated by the actual speed signal.

12. The motor drive device according to claim 11, wherein
the update signal generator generates the update signal based on a rotor position signal of the motor for which the actual speed signal is generated.

13. A motor drive method comprising:
generating an actual speed signal indicating an actual speed of a motor;
generating a target speed signal indicating a target speed of the motor;
comparing the actual speed indicated by the actual speed signal and the target speed indicated by the target speed signal;
generating a speed command signal according to an output from the comparing; and
generating a drive signal for driving the motor from the speed command signal, wherein
the generating of the speed command signal includes:
generating, according to the output from the comparing, a step width signal indicating a step width including a size and a positive or negative sign that correspond to a magnitude of one of the actual speed or the target speed with respect to an other of the actual speed or the target speed;
repeatedly generating one or more update signals; and
adding the step width indicated by the step width signal to the speed command signal and outputting a resulting speed command signal, at a timing of each update signal repeatedly generated.
